(19) United States
(12) Patent Application Publication
(10) Pub. No.: US 2007/0298798 A1
(43) Pub. Date: Dec. 27, 2007

(54) Method and System of Radio Communications

(75) Inventors: Bo Hagerman, Tyreso (SE); Thomas Ostman, Spanga (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/573,335

(22) PCT Filed: Jul. 21, 2005
(86) PCT No.: PCT/IB05/52440

§ 371 Date: Feb. 6, 2007

(30) Foreign Application Priority Data
Aug. 6, 2004 (SE) 0402003-8

(51) Int. Cl. H04Q 7/38; H04B 7/005

(52) U.S. Cl. 455/436; 455/453; 455/522

(57) ABSTRACT

The present invention relates to communications. More especially it relates to handover of connections. Particularly it relates to soft handover of connections between cells or sectors providing optimized performance in hand over boundary or region balancing various coverage ranges.

### TECHNICAL FIELD OF THE INVENTION

The present invention relates to communications. More especially it relates to handover of connections. Particularly it relates to soft handover of connections between cells or sectors providing optimized performance in hand-over boundary or region. This is very attractive in, e.g., CDMA (‘Code Division Multiple Access’) or WCDMA (‘Wideband CDMA’) systems, and multiple access systems based on OFDM (‘Orthogonal Frequency Division Multiplex’).

### BACKGROUND AND DESCRIPTION OF RELATED ART

Handover of connections as such are well known in the art. At hard handover one (old) communication link or path is released prior to a (new) communication link being completely established. However, the process is fast and hardly noticeable to a user during normal conditions in a well-designed system with good coverage. In contrast, at soft handover communication links are abandoned and established in such a manner that user equipment always keeps at least one communication link. According to prior art, generally some directional dependent hysteresis is included such that a required level for establishing a (new) communication path is greater than the level at which a (old) communication path is released or lost.

An active set is, in accordance with 3GPP specifications, a set of radio links simultaneously involved in a specific communication service between a User Equipment and a terrestrial radio access network access point.

FIG. 1 illustrates the principles of diversity handover or soft handover of User Equipment, UE, with two base stations <<BS1>>, <<BS2>> of a radio access network, each base station serving a cell <<Cell1>>, <<Cell2>>. In the figure User Equipment <<UE>> has established communication paths <<Path1>>, <<Path2> with both base stations <<BS1>>, <<BS2>>.

In prior art systems, a measurement level considered for hand over decisions usually includes received power on a pilot channel. In UMTS (‘Universal Mobile Telecommunications System’), e.g., the level considered is received power on (Primary) Common Pilot Channel, CPICH, at User Equipment, UE.

FIG. 2 schematically illustrates the hysteresis of received power on CPICH from two different base stations/Nodes B <<BS1/Node B1>>, <<BS2/Node B2>>, at a User Equipment <<UE>> in a situation when a connection is established via a base station <<BS2>>, while maintained via another base station <<BS1>>. The region where the difference between received transmission power from the base stations <<BS1>>, <<BS2>>, is smaller than or equal to the hysteresis <<η>> is the handover boundary <<HOB>>.

International Patent Application WO0232017 describes in relation to its FIG. 3 a transmit antenna array using a conventional soft handover scheme. Base stations Node B1 and Node B2 decrease their transmission power and at the same time UE calculates weights depending on a phase difference between the CPICH signals transmitted from the two Nodes B so as to maximize SINR (‘Signal to Interference+Noise Ratio’) and transmits the weights to the Nodes B. UE then soft-combines the signals received from the Nodes B according to the weights and determines weights maximizing SINR of the soft-combined signals.

U.S. Pat. No. 6,011,971 discloses combined soft and hard handover and identifies a power control problem in relation to hard handover.

3^{rd} Generation Partnership Project (3GPP): Technical Specification Group Radio Access Network, Physical Layer Procedures, 3G TS 25.214 v3.3.0, France, June 2000, describes out of synchronization handling. Briefly, poor quality link sets are indicated to be out of sync. Regarding uplink power control, the MS shall shut its transmitter off during downlink out-of-sync conditions. If the receive timing for any link, during soft handover, drifts to lie outside a valid range, information shall be provided, so that the network can adjust downlink timing.

Basically, according to the 3GPP technical specification a TPC command comprises one bit, indicating a power increase or decrease. However, the invention does not exclude basic TPC commands comprising more than one bit. Further according to the 3GPP technical specification, during soft handover there is one such basic TPC bit or TPC command for each of the links involved, to be combined into a TPC command. Consequently, the concept “TPC command” comprises both such basic and combined TPC commands. Regarding downlink power control, during out-of-sync periods the TPC command transmitted shall be set as “1”, i.e. it shall indicate a power increase.

3^{rd} Generation Partnership Project (3GPP): Technical Specification Group Radio Access Network, Physical layer—Measurements (FDD), 3GPP TS 25.215 v6.0.0, France, December 2000, specifies in section 5.2 UTRAN (‘Universal Terrestrial Radio Access Network’) measurements. In subsection 5.2.3. SIRₑᵣᵣₒᵣ is defined:
SIRₑᵣᵣₒᵣ=SIR−SIR_{target}_{_{—}}ₐᵥₑ,
where SIR is signal to interference ratio measured by UTRAN, in dB, and SIR_{target}_{_{—}}ₐᵥₑ is an average of target signal to interference ratio, SIR_{target}, averaged over the same time period as signal to interference ratio measured by UTRAN. In compressed mode SIR_{target} equals SIR_{cm}_{_{—}}_{target} and is not calculated over the transmission gap. The averaging of SIR_{target} is made in linear scale, and SIR_{target}_{_{—}}ₐᵥₑ is in dB.

None of the cited documents above discloses a method and system providing optimized handover boundary or region of power control for continuous mobile station transmission power at handover with unsymmetrical handover ranges in terms of distance or pilot channel transmission power.

### SUMMARY OF THE INVENTION

When designing soft handover to be established based upon received power of a pilot channel, such as CPICH in WCDMA systems, the signal quality of the different handover or diversity branches may differ substantially. Also, received signal quality may differ substantially for uplink and downlink directions of a connection. This problem generally entails in, e.g., WCDMA and OFDM systems.

Among the reasons for this are:
1. Noise or interference level at a base station of one diversity branch is substantially greater than at a base station of another diversity branch.
2. Cell coverage in terms of received transmission power in downlink direction differs substantially from cell coverage in terms of SIR or SINR at UE.
3. Antenna diagram, radiation pattern or footprint cannot be varied or would be too costly to vary.
4. Different receiver sensitivity of base station receivers for different base stations.

Consequently, there is a need of providing eligible or optimized coverage patterns in relation to quality.

It is consequently an object of the present invention to achieve a communications system compensating for different coverage in uplink and downlink directions or different quality coverage in uplink or downlink of different cells.

A further object is to provide a method and system of quality control independent of base station receiver performance.

It is also an object to achieve a method and system of quality control independent of actual antenna gain of base station installation.

Another object is to provide a method and system tailored to the actual cell sites involved at a particular soft handover boundary.

Finally, it is an object to fully control cell size and optimize cell size for various radio access bearers, RABs, and the different requirements of the services they provide.

These objects are met by a method and system of adding noise or interference in a base station receiver path, injecting noise or interference, or adapting a noise equivalent level of transmission power control in relation to handover.

### BRIEF DESCRIPTION OF THE DRAWINGS

FIG. 1 illustrates the principles of diversity handover or soft handover of User Equipment, UE, with two base stations <<BS1>>, <<BS2>> each serving a cell <<Cell1>>, <<Cell2>>.

FIG. 2 schematically illustrates the hysteresis of received power on CPICH from two different base stations/Nodes B according to prior art.

FIG. 3 illustrates the interrelations between data rates/sub-channels and sub-codes/spreading factors for a code multiplexed system such as a WCDMA system.

FIG. 4 illustrates example antenna coverage patterns in horizontal plane of two base stations for downlink and uplink together with downlink handover region of prior art and uplink handover region according to the invention.

FIG. 5 schematically illustrates uplink transmission power <<UL TP>> emitted by a User Equipment versus position of the User Equipment.

FIG. 6 illustrates schematically downlink transmission power emitted to a particular User Equipment versus position of the User Equipment when moving along an imaginary straight line between the two base stations of FIG. 4.

FIG. 7 illustrates example ranges for a particular user in the form of antenna coverage patterns in horizontal plane of two base stations similar to those of FIG. 4.

FIG. 8 schematically illustrates uplink transmission power versus position for User Equipment moving along an imaginary straight line in direction from the base station with greater uplink coverage range towards the base station <<BS A>> with less uplink coverage range in FIG. 7.

FIG. 9 schematically illustrates base station downlink transmission power vs. position for a particular User Equipment moving along a straight line between two base stations in direction from base station of greater range of uplink coverage towards base station of less range of uplink coverage for the two example handover regions of FIG. 7.

FIG. 10 illustrates by an example flow chart an alternative to noise injection in the receiver path according to the invention a second embodiment controlling noise addition in power control algorithm determining TPC (‘Transmission Power Control’) bits to send for uplink transmission power control according to the invention.

FIG. 11 illustrates a principal block diagram of relevant parts of a base station operating according to the invention.

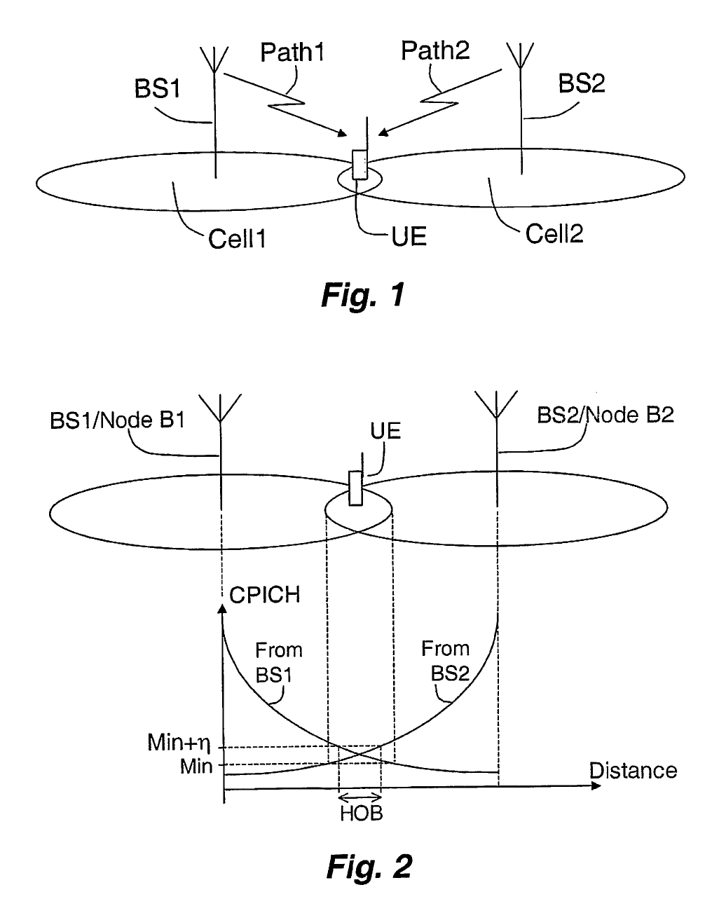

### DESCRIPTION OF PREFERRED EMBODIMENTS

When designing soft handover to be established based upon received power of a pilot channel, such as CPICH in WCDMA systems, the signal quality of the different handover or diversity branches may differ substantially. Also, received signal quality may differ substantially for uplink and downlink directions of a connection due to uplink and downlink unbalances. The differences can be dependent on UE position or instant distances to base stations. In relation to quality the differences cause coverage asymmetries. This problem generally entails in, e.g., WCDMA and OFDM systems.

The reason for this being a problem is at least fivefold:
1. When interference or noise level differs substantially in uplink direction to two or more base stations, power control algorithms will tend to keep transmission power at smallest possible level, this transmission power level will provide a sufficient quality at a base station with small interference and noise levels but not at more heavily disturbed base stations. Thereby, diversity gain from one or more additional branches with heavy noise or interference will be small or negligible.
   This may result in an old cell being kept too long for efficient use of resources or equivalently the handover boundary to a handover candidate is too far from the base station serving the old cell.
   Another consequence is increased interference level to other users of the already heavily disturbed base stations due to the established soft handover diversity branch at no or negligible performance gain to the disturbing user.
2. When handover is based on received power level and not on a power control related quality measure such as SIR or SINR, there is an increased risk of one or more communication branches to base stations being out of sync due to small SIR or SINR. This will increase the risk of a call being dropped.
3. Today's WCDMA systems are generally designed with power level of CPICH set equally at the antenna connector of transmitting base stations, with CPICH power level being set as a function of total available power at the base station. With handover boundaries being set based upon received power level of CPICH, cell boundary can only be controlled by antenna radiation pattern.
   Varying antenna radiation pattern may not be available at old antenna installations.
   Varying antenna radiation pattern could be very tedious or costly, depending on type of antenna.
Consequently, often it is not possible to adapt antenna radiation pattern in relation to varying surface distribution of traffic, which may end up in an excessive number of blocked calls.
4. When determining handover boundary in relation to received power on CPICH from different base stations, no regard is paid to possibly different sensitivity of the receivers of the different base stations. This could substantially affect the User Equipment transmission power required by different base stations. Consequently, there is an increased risk of dropped calls due to the disregard of actual receiver sensitivity.
5. Traffic capacity will deteriorate in terms of increased block rate particularly in a cell with inferior downlink coverage due to handover incapability, thereby prohibiting capacity optimization.

According to the invention quality is preferably measured in terms of signal to interference ratio, SIR, or signal to interference and noise ratio, SINR. Also according to the invention, virtually any quality measure with a strong relationship to the measure upon which power control is based could be used.

The invention also contributes to solving the power control problem of hard handover in CDMA systems described in International Patent Application WO0232017.

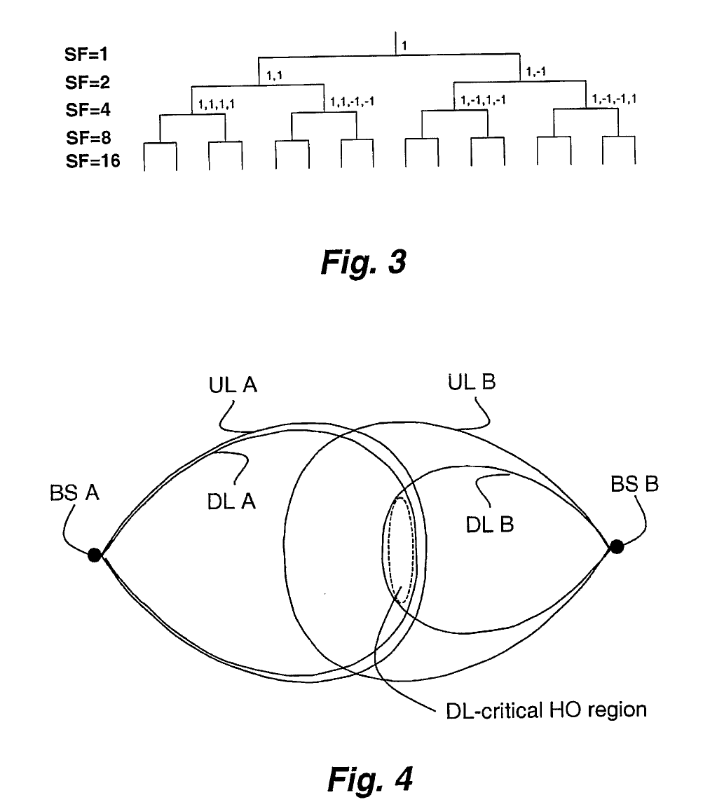

In Code Division Multiple Access, respective digital user signals are separated by individual spreading codes. Each code represents a spreading factor. Sub-channels or lower rate channels are separated by sub-codes with a greater spreading factor. FIG. 3 illustrates the interrelations between data rates/sub-channels and sub-codes/spreading factors for a code multiplexed system such as a WCDMA system. It displays a binary code tree where a spreading factor, SF, equal to one occupies the entire code tree, i.e. all levels indicated by SF=2, SF=4, SF=8 and SF=16. This spreading factor translates into the highest user data rate. A sub-code with a spreading factor equal to two occupies only half the tree, the leftmost sub-tree or the rightmost sub-tree, in each case the sub-tree occupying the levels indicated by SF=4, SF=8 and SF=16 preventing other users from using the corresponding codes. Similarly, if a user is assigned a sub-code corresponding to a spreading factor equal to four, he occupies a sub-tree (and corresponding sub-channels) originating from the level indicated by SF=4 down to SF=16. Spreading factor four represents a medium user data rate. A user allocated a channel of spreading factor 16 occupies the lowest data rate in this example figure. Spreading codes for SF=1, SF=2 and SF=4 are denoted at the root of the corresponding sub-tree. This code tree is only an example not limiting the scope of the invention.

According to a preferred embodiment of the invention in a WCDMA system, for active user equipment noise or interference is adaptively added to a received signal in at least one uplink, thereby compensating for different power levels of CPICH at a chosen or optimized cell boundary or different uplink quality of different uplinks at an existing cell boundary determined from received power level of CPICH. If noise were added to the RF (‘Radio Frequency’) receiver path all radio links could possibly be affected by the noise. Preferably, noise is hence added after despreading for a particular user of received signal in a WCDMA system. According to a preferred mode of the invention noise is added after despreading with spreading factor 4 (SF=4) when all radio links are despread with SF=4 prior to further despreading depending on allocated capacity. The noise could also be added to a group of users by injection at particular selected steps of despreading or selected spreading factor.

Similarly, in an example OFDM system where users share a great number of carriers and are allocated capacity of the shared carriers, noise is preferably added after filtering or inversely transforming a received signal enhancing signal components of a particular user.

A particular problem being one example cause of unbalances of uplink and downlink signal levels is the use of top mast amplifiers, TMAs, or low noise amplifiers, LNAs, in antenna masts of base station installations for uplink signals. The TMA amplifies received signal close to antenna feeder point and compensates for noise and attenuation of antenna cable to base station according to principles known in the art and thereby improves installation sensitivity. In downlink direction, however, noise and attenuation has to be compensated for by the base station. Without particular feedback of transmitted and received signal levels at antenna feeder point this match is hardly ever perfect. Further, antenna radiation patterns of transmit and receive antennas are rarely perfectly matched. In addition, CPICH is restricted by base station maximum transmission power and CPICH function of base station transmission power.

With mobile assisted handover, MAHO, user equipment measure received downlink signal level of common pilot channel, CPICH.

FIG. 4 illustrates example ranges for a particular user in the form of antenna coverage patterns in horizontal plane of two base stations <<BS A>> and <<BS B>> for uplink <<UL A>>, <<UL B>> and downlink <<DL A>>, <<DL B>>. In more detail, the solid lines of the respective coverage range patterns indicates a particular reception level for a user equipment transmitting/receiving signals on the line for a given transmission power level. In the figure uplink coverage range <<UL A>>, <<UL B>> is substantially equal for both base stations <<BS A>>, <<BS B>>. Downlink coverage <<DL A>>, <<DL B>> differs substantially for the two base stations <<BS A>>, <<BS B>>. This can be due to, e.g., the base stations <<BS A>>, <<BS B>> operating with different power levels of CPICH. Attenuation of antenna feeder cables in some existing installations differs substantially between base stations. For downlink it is critical for maintaining a connection of a mobile moving towards either of the base stations <<BS A>>, <<BS B>> that a handover of downlink connection has been established within a region of coverage <<DL-critical HO region>>.

When downlink coverage and downlink capacity is allowed to influence also uplink handover region, according to the invention, the handover of also uplink would occur in handover region <<DL-critical HO region>> located closer to the base station of more limited downlink coverage <<BS B>> than indicated by the uplink coverage patterns.

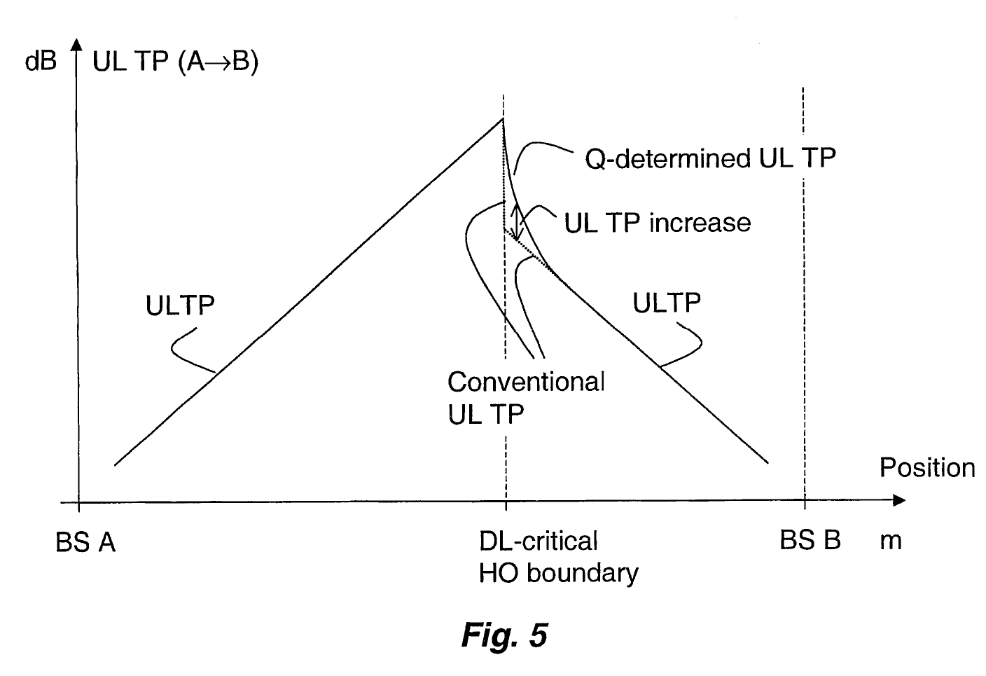

FIG. 5 schematically illustrates uplink transmission power <<UL TP>> emitted by a User Equipment versus position of the User Equipment. In the figure the User Equipment position is moving along an imaginary straight line between the base stations <<BS A>>, <<BS B>> illustrated in FIG. 4, the base stations <<BS A>>, <<BS B>>, having coverage patterns for the User Equipment corresponding to those in FIG. 4. In FIG. 5 User Equipment moving in direction from the base station <<BS A>> with comparatively greater coverage range towards a base station <<BS B>> with less coverage range <<UL TP (A→B)>>. A feature is that transmission power according to the invention <<Q-determined UL TP>> (solid line) is controlled to decrease smoother than for a conventional handover <<Conventional UL TP>> determined solely based upon downlink transmission power. This would cause a minor power increase <<UL TP increase>> as compared to the conventional handover in the entered cell. With its smooth variation vs. distance, this can be balanced by other users' injected noise/interference.

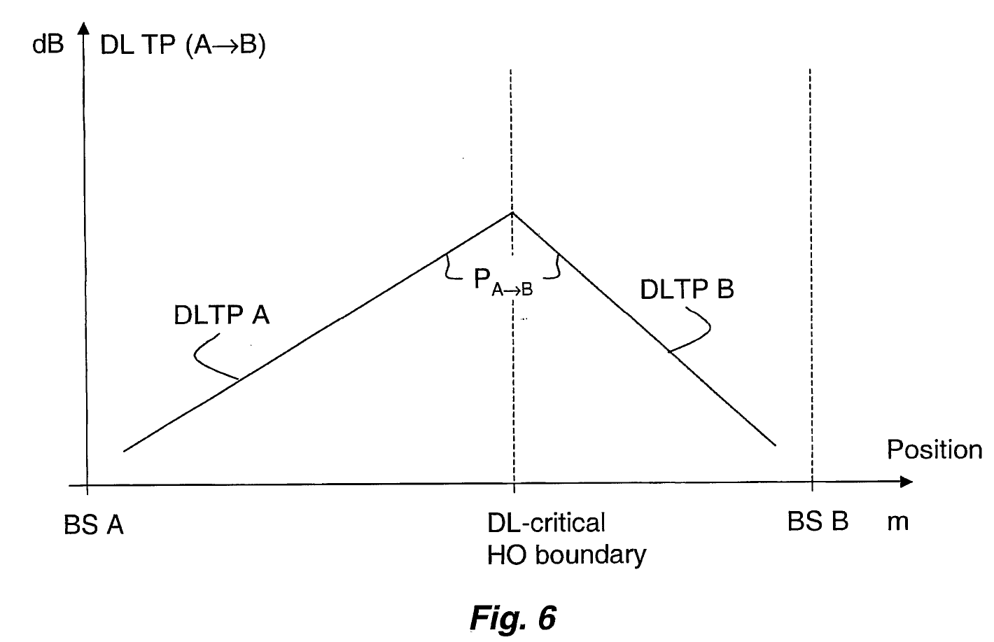

FIG. 6 illustrates schematically downlink transmission power <<DL TP (A→B)>>, <<P_{A→B}>> emitted to a particular User Equipment versus position of the User Equipment when moving along an imaginary straight line between the two base stations of FIG. 4 <<BS A>>, <<BS B>>. Essentially, the downlink transmission power comprises transmission power <<DL TP A>> from the base station of greater coverage range <<BS A>> prior to handover and transmission power <<DL TP B>> from the base station of less range <<BS B>> when handover has been executed which is illustrated to occur at the left dotted line <<Q-determined HO boundary>>.

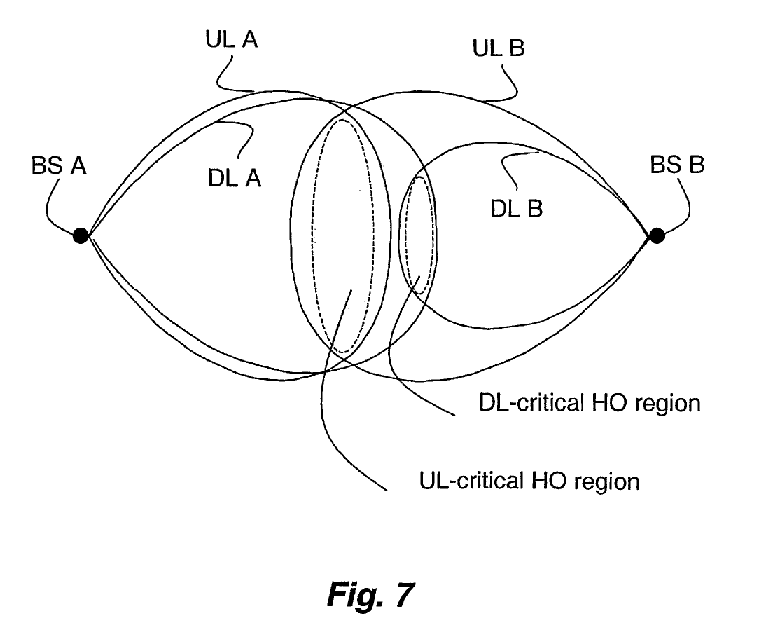

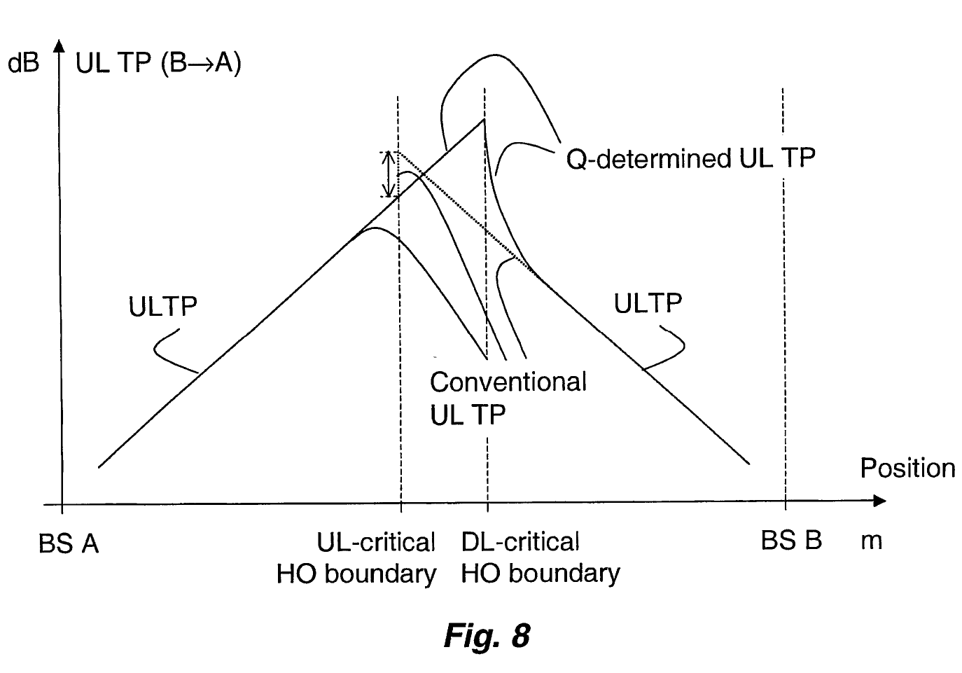

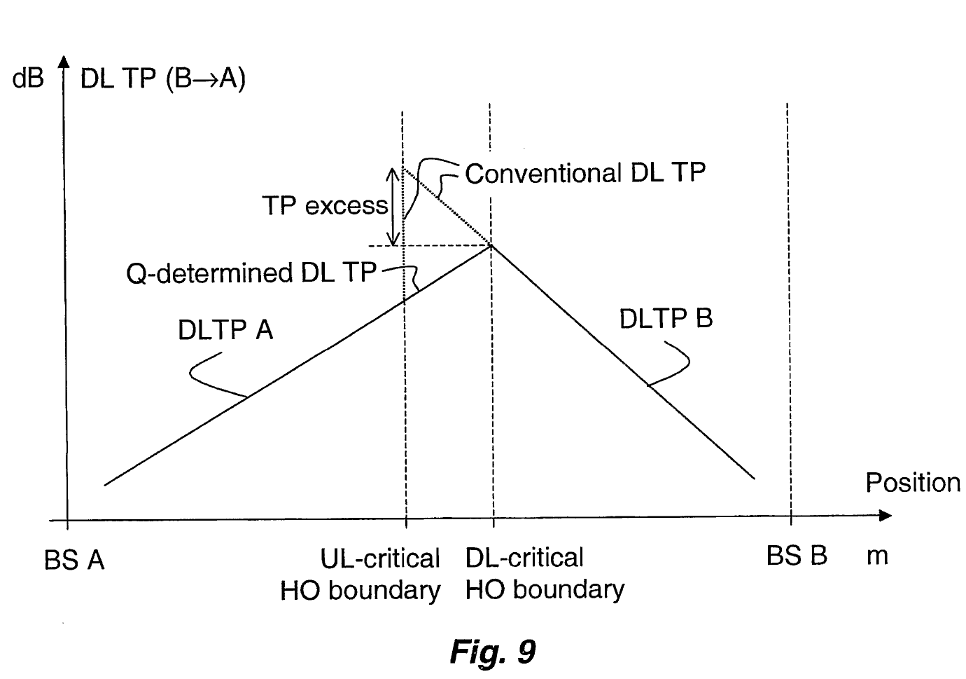

FIG. 7 illustrates example ranges for a particular user in the form of antenna coverage patterns in horizontal plane of two base stations <<BS A>>, <<BS B>> similar to those of FIG. 4. The downlink coverage <<DL A>>, <<DL B>> of the base stations <<BS A>>, <<BS B>> is identical to that of FIG. 4. In contrast to FIG. 4, FIG. 7 comprises somewhat different uplink coverage <<UL A>>, <<UL B>> of the two base stations in relation to a User Equipment. The range differences can be due to e.g. different interference conditions or different sensitivity of the base station receivers. In addition to FIG. 4 a second handover region <<UL-critical HO region>> is included. Within this region it is critical for maintaining a connection of a mobile moving towards either of the base stations <<BS A>>, <<BS B>> that a handover of uplink connection has been established. For the example coverage ranges there is a great risk of losing connection when moving in direction from base station B to base station A using conventional handover due to User Equipment not getting in-sync with the base station <<BS A>> of less uplink coverage range. This will be explained in further detail in relation to FIGS. 8 and 9.

FIG. 8 schematically illustrates uplink transmission power <<UL TP (B→A)>> versus position for User Equipment moving along an imaginary straight line in direction from the base station <<BS B>> with greater uplink coverage range towards the base station <<BS A>> with less uplink coverage range in FIG. 7. With conventional handover User Equipment would increase uplink transmission power <<Conventional UL TP>> as it comes further away from the base station it is leaving. As the User Equipment advances further away from the base station it is leaving <<BS B>> the greater is the required uplink transmission power <<Conventional UL TP>>, <<UL TP>>. This is the case until the User Equipment is in sync with the base station it is approaching <<BS A>>. Due to the less uplink coverage range of the approached base station <<BS A>> and the limited transmission power of UE, UE is required to get closer to the approached base station <<BS A>> with conventional handover <<Conventional HO boundary>> than according to the invention. Thereby, interference level is increased in the cell/sector served by the approached base station <<BS A>>, which is not compensated for in the same sense as according to the invention. According to the invention <<Q-determined UL TP>>, User Equipment increases transmission power <<UL TP>> due to noise injection as described above. Due to the power increase User Equipment can get in sync with the base station it is approaching <<BS A>> at a position closer to the base station it is leaving than would be the case for conventional handover <<Conventional handover boundary>> According to the invention the uplink handover boundary could be close to the downlink handover boundary (depending on hysteresis level) <<Q-determined HO boundary>> and the possible interference increase in the cell served by the base station UE is leaving <<BS B>> could be balanced by noise injection and choice of hysteresis.

FIG. 9 schematically illustrates base station downlink transmission power <<DL TP (B→A)>> vs. position for a particular User Equipment moving along a straight line between two base stations,, <BS A>>, <<BS B>> in direction from base station of greater range of uplink coverage <<BS A>> towards base station of less range of uplink coverage for the two example handover regions of FIG. 7. The downlink transmission power relates to the uplink transmission power in FIG. 8. As explained in relation to FIG. 8, with uplink transmission power according to conventional handover <<Conventional UL TP>> UE is required to be comparatively closer to the approached base station than with uplink transmission power according to the invention <<Q-determined UL TP>> for UE uplink to acquire in-sync status and the handover be executed. This can be due to, e.g., greater sensitivity of the distanced base station <<BS B>> rendering greater range uplink coverage. This leads to differences also concerning downlink. With reference to FIG. 9, according to conventional handover transmission power <<Conventional DL TP B>>, <<DL TP B>> from the distanced base station <<BS B>> is required to increase further <<TP excess>>, <<Conventional DL TP B>> compared to handover according to the invention <<Q-determined DL TP>>. Since the downlink range coverage of the distanced base station <<BS B>> is less than the downlink range coverage of the approached base station <<BS A>>, as discussed in relation to FIG. 7, there is then, in addition to the negative impact of the increased transmission power, a great risk of UE losing connection due to no radio uplink being established to the approached base station <<BS A>>, which can be caused by uplink not getting in sync in due time for handover. According to the invention, however, as an uplink for handover can be established closer to the distanced base station <<BS B>>, prerequisites can be fulfilled for a handover of both uplink and downlink to be satisfactorily accomplished in the intermediary between boundaries close to the DL-critical and UL-critical handover boundaries <<DL-critical HO boundary>>, <<UL-critical HO boundary>>. Apparently, FIG. 9 illustrates two advantages according to the invention: reduced <<TP excess>> downlink transmission power <<DL TP (B-4A)>>, <<DL TP A>>, <<DL TP B>> and reduced risk of losing connection due to UE connection with distanced base station <<BS B>> getting out of sync beyond downlink range coverage <<DL-critical boundary>>. The greater downlink transmission power of the conventional handover further increases interference level in the cell served by the approached base station <<BS A>> and the cell served by the distanced base station <<BS B>>. This interference increase is not balanced, in contrast to the case described above for uplink handover according to the invention. Further, conventional handover would put additional restrictions on low hysteresis levels, as an attempt to reduce the risk of dropped calls.

To achieve the advantages of the invention described in relation to FIGS. 4-9 a preferred power level of noise, injected at a (distanced) base station B in addition to noise possibly injected at a (approached) base station A, is determined (in dB or log-scale) as
N_{BA}=P_{CPICH,A}−P_{CPICH, B}−S_{BS,A}+S_{BS, B},
where, for a connection to be established to base station A serving cell A, N_{BA} is power level difference of injected noise at base station B in relation to cell A for a handover boundary between the cells A and B; P_{CPICH,A} is received transmission power in UE from base station A at the boundary; P_{CPICH, B} is received transmission power in UE from base station B at the boundary; S_{BS, A} is receiver sensitivity of base station A; and S_{BS, B} is receiver sensitivity of base station B.

As an alternative noise injection level is determined independently at each base station (in dB or log-scale):
N_{A}=C+S_{BS, A}−P_{CPICH, A},
N_{B}=C+S_{BS, B}−P_{CPICH, B},
where N_{A} is noise injection power level at base station A and N_{B} is noise injection power level at base station B and C is a constant, which is preferably set equal to zero. Preferably noise is only injected conditionally, conditioned on the base station being the distanced base station or base station with one or more established links to the User Equipment (N_{A}=0 for base station A being the approached and base station B being the distanced base station), thereby both maximizing impact and keeping noise and interference levels at a minimum for most installations.

The absolute value of N_{BA},=N_{B}−N_{A}, |N_{BA}|, reflects the power excess of noise injection, comparing cells. If conditions are such that N_{BA}, according to the expression above is positive for two cells, cell A and cell B, noise of power level |N_{BA}| is added to the receiver path of base station B. Only positive noise power levels could be added to a receiver path. If N_{BA}, in accordance with the expressions above, would be negative for an approached cell A and a distanced cell B, preferably no noise is added.

It should be noted that noise or interference should be injected only for links being in sync. Also, noise or interference should preferably only be injected to links with SIR error below a particular threshold, e.g. 2 dB, in order to exploit receiver sensitivity for adjusting handover boundary only when this is needed. If the SIR error exceeds the particular threshold, this could be due to UE operating at its maximum power level and not being capable of further increasing it, according to the invention. The preferable particular SIR error threshold depends on configuration of outer power control loop in controlling RNC, CRNC.

As an alternative to noise injection in the receiver path as described above a similar results is obtained according to a second embodiment controlling noise addition in power control algorithm determining TPC (‘Transmission Power Control’) bits to send for uplink transmission power control.

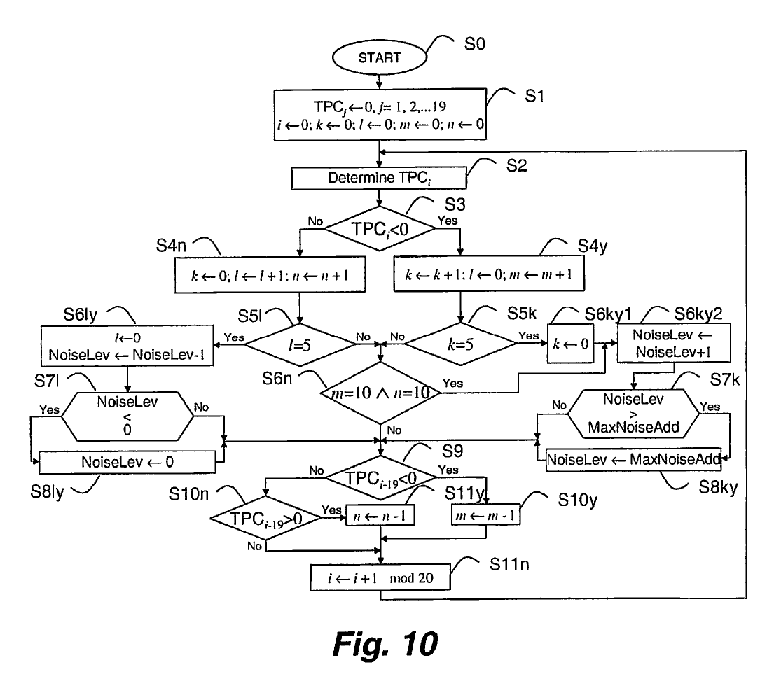

In FIG. 10 this is illustrated by an example flow chart:
If there are 5 consecutive TPC bits sent from the base station all of which commanding UE to reduce transmission power, <<TPCᵢ<0>>, 1 dB of noise is added in the uplink transmission power control algorithm, unless the resulting added noise exceeds a maximum level <<Max Noise Add>>.
If there are 5 consecutive TPC bits sent from the base station all of which commanding UE to increase transmission power, TPCᵢ>0 (determined TPCᵢ <<Determine TPCᵢ>>, <<TPCᵢ>>0 being either positive or negative), 1 dB of noise is subtracted in the uplink transmission power control algorithm.
If there are 10 TPC bits indicating a power increase, <<TPCᵢ>0>>, and 10 TPC bits indicating a power decrease, <<TPCᵢ<0>>, sent from the base station out of 20 consecutive TPC bits, 1 dB of noise is added in the uplink transmission power control algorithm, unless the resulting added noise exceeds a maximum level <<Max Noise Add>>. The latest 20 consecutive TPC bits are considered, counting indices modulo 20. For this reason, the impact of oldest TPC-bit <<TPCᵢ₋₁₉>> is eliminated for each new TPC-bit value <<Determine TPCᵢ>>. During initialization old TPC-bit values are preferably set to zero <<TPCⱼ0, j=1.2, . . . 19>>. When eliminating old TPC-bit values, impact of determined TPC-bits are considered and initialization values, TPCᵢ₋₁₉=0, are disregarded.

Described in more detail, FIG. 10 illustrates a method of initiating a number parameters <<S1>> for proper operation after start <<S0>>. With a method depending on 20 TPC bits, TPC bits not yet available (TPCⱼ, j=1,2, . . . 19) are initialized to zero thereby distinguishable from non-zero determined values, determined from measurement data. Counters i, k, l, m, n are all set to zero.

For each iteration a TPC bit is determined <<S2>>. If transmission power should increase, TPCᵢ is greater than zero, and if transmission power should decrease, TPCᵢ is less than zero.

If TPCᵢ is less than zero <<S3>>, it is considered <<S4y>> to be a candidate to be one of five consecutive equal TPC bits less than zero (k→k+1). Obviously it is not one of five consecutively equal TPC-bits greater than zero (l→0). It could be one of 10 TPC-bits less than zero out of 20 consecutive TPC bits (m→m+1).

If TPCᵢ is not less than zero <<S3>>, it is considered <<S4n>>to be a candidate to be one of five consecutively equal TPC-bits greater than zero (l→l+1). Obviously it is not one of five consecutively equal TPC-bits less than zero (k→0). It could be one of 10 TPC-bits greater than zero out of 20 consecutive TPC bits (n→n+1).

If k=5 <<S5k>> there has been five consecutive TPC-bits less than zero. Then another sequence of five consecutive TPC bits is initiated (k→0) <<S6kyl>> and the noise equivalent level is increased (NoiseLev→NoiseLev+1) <<S6ky2>>. If k≠5, there are not five consecutive equal TPC bits, but could as well be among 10 TPC bits greater than zero out of 20 consecutive TPC bits <<S6n>>. If this is the case the noise equivalent is increased (NoiseLev→NoiseLev+1) <<S6ky2>>.

Similarly, if there are five consecutive non-negative TPC-bits <<S6ly>> another sequence of five consecutive TPC bits is initiated (l→0) and the noise equivalent level is decreased (NoiseLev→NoiseLev−1) <<S6ly>>.

The noise equivalent level is checked not to be set less than zero <S71>>, <<S81y>> and not to be greater than a maximum level MaxNoiseAdd <<S7k>>, <<S8ky>>.

The method proceeds by phasing out old TPC bits, in the example the oldest out of 20 bits (TPC₁₉) is phased out <<S9>>, <<S10n>>, <<S10y>>, <<S11y>>. If the oldest TPC bit considered is less than zero <<S9>> then the record of number of negative TPC bits is decreased by one <<S11y>>. If the TPC bit is not less than zero, it is checked whether it is greater than zero (or if it is non-zero) <<S10n>>. If the oldest TPC bit considered is greater than zero <<S10n>> then the record of number of non-negative TPC bits is decreased by one <<S11y>>. After appropriate adjustments of counters <<S10y>>, <<S11y>> or if the TPC bit equals an initialization value from the initialization <<S1>> the TPC bit is phased out and the iteration counter and pointer to current position for buffered TPC bits is increased by one (i→i+1 mod 20) <S11n>>. As a maximum of 20 consecutive TPC bits are considered it is increased modulo 20 <<S11n>>.

A radio frame in WCDMA corresponds to 15 TPC bits. By the use of multiples of preferably 5 of TPC bits considered, rational number of TPC bits per radio frame is achieved. Further, 5 TPC bits is sufficiently short in time for short term or instantaneous power control slope detection and sufficiently great for a reliable result. The number of TPC bits preferred (20 TPC bits) for determining an average (longer term) slope is preferably a multiple of number of TPC bits considered for short term peak/instantaneous slope detection. However, the invention is not restricted to these preferred number of TPC bits, even if they imply realization advantages.

In a further embodiment, noise/interference addition as described in relation to embodiment 1 or 2 is initially included for a particular user equipment, UE, during handover. When the user equipment uplink gets in sync with an approached base station and the handover has been executed the noise/interference addition is interrupted and the distanced (old) base station is controlled to deliver TPC commands commanding power increases, thereby leaving effective transmission power control to the approached base station since UE is designed to transmit at least commanded power level when there are conflicting TPC commands. The distanced (old) base station stops the process when the handover is completed.

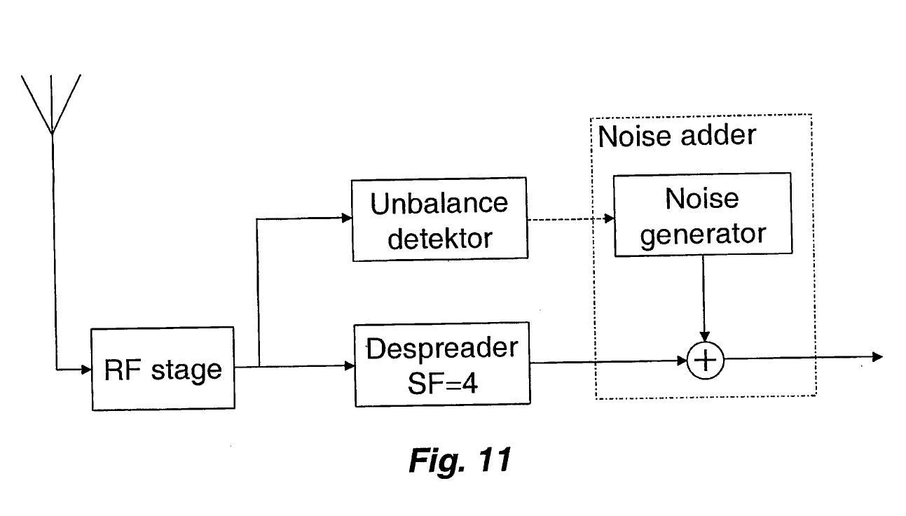

FIG. 11 illustrates a principal block diagram of relevant parts of a base station operating according to the invention. Received signals are processed in an initial stage <<RF stage>> for filtering, frequency translation etc. rendering the signal appropriate for demultiplexing or despreading and detection of unbalances. The signal is further demultiplexed or despread, preferably with spreading factor 4 <<Despreading SF=4>> and unbalances are detected <<Unbalance detector>>. Unbalances can be detected in various ways according to the invention. As an example uplink signal measurements can be performed by base station and compared to measurements performed by UE or performed by another base station and reported via UE or directly to the instant base station. Another example is base station relying entirely on reported level or ranges and comparing the reported values for determining compensation. Information on the detected unbalance is fed to a noise or interference generator <<Noise generator>> generating noise or interference of appropriate power level. The noise or interference is fed to an adder <<⊕>> adding the generated noise or interference to the despread signal. The composed signal is output from the adder <<⊕i>>. The combination of noise and interference generator <<Noise generator>> and adder forms a noise adder <<Noise adder>>.

The invention is not restricted to particular acronyms used in the description or to particular systems mentioned. The invention covers all systems and equipment operating analogously to the described.

The invention is not intended to be limited only to the embodiments described in detail above. Changes and modifications may be made without departing from the invention. It covers all modifications within the scope of the following claims.

1-52. (canceled)

53. A method of handover of radio communications in a system comprising base station radios having coverage ranges of received radio frequency signals and transmitted radio frequency signals, comprising the step of:
compensating radio coverage range unbalances between downlink or uplink directions of different base stations by noise or interference addition to one or more received signals or by inclusion of one or more noise or interference equivalent parameters of transmission power control.

54. The method according to claim 53, wherein the noise or interference addition adds noise posterior to demultiplexing of received one or more signals.

55. The method according to claim 53, wherein the noise or interference addition adds noise posterior to despreading of received one or more signals.

56. The method according to claim 55, wherein the despreading of received one or more signals despreads the one or more signals with spreading factor 4.

57. The method according to claim 56, wherein the despread one or more signals are further despread.

58. The method according to claim 57, wherein the further despreading comprises one or more steps of despreading by a factor of two.

59. The method according to claim 53, wherein the added noise or interference, or the one or more noise or interference equivalent parameters, is determined in response to a comparison between performance of a base station with an established connection and a base station to which connection is going to be established.

60. The method according to claim 59, wherein the performance comparison includes base station receiver sensitivity.

61. The method according to claim 59, wherein the performance comparison includes base station transmission power received in user equipment.

62. The method according to claim 59, wherein the performance comparison includes base station antenna feeder cable attenuation.

63. The method according to claim 59, wherein the performance comparison includes base station antenna gain in relation to a particular User Equipment.

64. The method according to claim 53, wherein the added noise or interference, or the one or more noise or interference equivalent parameters, are determined in response to a comparison between uplink and downlink performance of a base station.

65. The method according to claim 64, wherein the performance comparison includes base station antenna feeder cable attenuation.

66. The method according to claim 64, wherein the performance comparison includes base station antenna gain in relation to a particular User Equipment.

67. The method according to claim 53, wherein the added noise or interference or the one or more noise or interference equivalent parameters, are determined in response to particular requirements of a radio access bearer or the one or more services provided by the radio access bearer.

68. A method of determining a parameter level for transmission power control, wherein the transmission power control influences a handover region of a radio communications connection, wherein the parameter level is noise or interference equivalent level, and wherein there is a first number of consecutive transmission power control symbols, said method comprising the steps of:
increasing the noise or interference equivalent level if a predetermined number of the first number of consecutive symbols indicate a transmission power increase, unless it would render the noise or interference equivalent level greater than a maximum level allowed; and,
compensating for radio coverage range unbalances between different base stations.

69. The method according to claim 68, wherein there is a second number of consecutive transmission power control symbols and the noise or interference equivalent level is increased if all of the second number of consecutive transmission power control symbols indicate a transmission power increase, unless it would render the noise or interference equivalent level greater than a maximum level allowed.

70. The method according to claim 69, wherein the noise or interference equivalent level is decreased if all of the second number of consecutive transmission power control symbols indicate a trans-mission power decrease, unless it would render the noise or interference equivalent level less than a smallest level allowed.

71. The method according to claim 68, wherein the first number of consecutive transmission power control symbols equals 20.

72. The method according to claim 68, wherein the predetermined number of the first number of consecutive symbols corresponds to at least one half of the first number of consecutive transmission power control symbols.

73. The method according to claim 69, wherein the second number of consecutive transmission power control symbols equals 5.

74. The method according to claim 53, wherein the noise or interference addition or the inclusion of a noise or interference equivalent parameter is interrupted when uplink to a base station, different from the base station at which noise or interference is added or noise or interference parameter is included, gets in sync.

75. The method according to claim 74, wherein when noise or interference addition or noise or interference inclusion is interrupted, transmission power control of the base station at which noise or interference is added or noise or interference is included commands a user equipment, to which the noise or interference addition or noise or interference parameter inclusion is related, to increase transmission power until handover is completed or the base station at which noise or interference addition or inclusion of noise or interference equivalent parameter is interrupted is no longer in the active set for the user equipment.

76. The method according to claim 53, wherein the radio communications are based on Code Division Multiple Access or Wideband Code Division Multiple Access principles.

77. The method according to claim 53, wherein the radio communications are based on principles of Orthogonal Frequency Division Multiplex.

78. A radio communications base station with radio coverage ranges of received radio frequency signals and transmitted radio frequency signals, the radio communications base station comprising:
detector means for detecting radio coverage range unbalances between downlink or uplink directions in relation to another base station; and,
compensation means comprising a noise or interference adder for adding noise or interference to one or more received signals or processing means for inclusion of one or more noise or interference equivalent parameters of transmission power control.

79. The radio communications base station according to claim 78 wherein the noise or interference adder comprises a noise or interference generator and an adder, the noise or interference generator being connected to the adder, said base station further comprising:
demultiplexing means for at least partially demultiplexing of one or more received signals, wherein the demultiplexing means is connected to the adder for adding noise or interference to the demultiplexed one or more received signals.

80. The radio communications base station according to claim 78, wherein the noise or interference adder comprises a noise or interference generator and an adder, the noise or interference generator being connected to the adder, said base station further comprising:
despreading means for at least partially despreading of one or more received signals, the despreading means being connected to the adder for adding noise or interference to the despread one or more received signals.

81. The radio communications base station according to claim 80, wherein the despreading means is arranged for despreading the one or more signals with spreading factor 4.

82. The radio communications base station according to claim 81, wherein the despreading means is arranged for further despreading of the one or more signals despread by spreading factor 4.

83. The radio communications base station according to claim 82, wherein the further despreading comprises despreading by a factor of two.

84. The radio communications base station according to claim 78, wherein the detector is arranged for detecting range unbalances between a base station with an established connection and a base station to which connection is going to be established.

85. The radio communications base station according to claim 78, wherein the detector is arranged for detecting range unbalances including base station receiver sensitivity.

86. The radio communications base station according to claim 78, wherein the detector is arranged for detecting range unbalances including base station transmission power received in user equipment.

87. The radio communications base station according to claim 78, wherein the detector is arranged for detecting range unbalances including base station antenna feeder cable attenuation.

88. The radio communications base station according to claim 78, wherein the detector is arranged for detecting range unbalances including base station antenna gain in relation to a User Equipment connected to the base station.

89. The radio communications base station according to claim 78, wherein the detector is arranged for detecting range unbalances including base station transmission power received in user equipment and base station transmission power received in base station.

90. The radio communications base station according to claim 89, wherein the detector is arranged for detecting range unbalances including base station antenna feeder cable attenuation.

91. The radio communications base station according to claim 89, wherein the detector is arranged for detecting range unbalances including base station antenna gain in relation to a User Equipment connected to the base station.

92. The radio communications base station according to claim 78, wherein the compensation means is arranged for adding noise or interference, or including one or more parameters of transmission power control, in response to particular requirements of a radio access bearer or the one or more services provided by the radio access bearer.

93. A radio communications base station, comprising:
processing means for increasing a noise or interference equivalent level, unless it would render the noise or interference equivalent level greater than a maximum level allowed, if a predetermined number of a first number of consecutive transmission power control symbols indicate a transmission power increase, the transmission power control influencing handover region of radio communications connection, the processing means being arranged for compensating radio coverage range unbalances between different base stations.

94. The radio communications base station according to claim 93, wherein the processing means increases the noise or interference equivalent level, unless it would render the noise or interference equivalent level greater than a maximum level allowed, if all of a second number of consecutive transmission power control symbols indicate a transmission power increase.

95. The radio communications base station according to claim 94, wherein the processing means decreases the noise or interference equivalent level, unless it would render the noise or interference equivalent level less than a maximum level allowed, if all of a second number of consecutive transmission power control symbols indicate a transmission power decrease.

96. The radio communications base station according to claim 93, wherein the first number of consecutive transmission power control symbols is equal to 20.

97. The radio communications base station according to claim 93 characterized by the predetermined number of the first number of consecutive symbols corresponds to at least one half of the first number of consecutive transmission power control symbols.

98. The radio communications base station according to claim 94, wherein the second number of consecutive transmission power control symbols is equal to 5.

99. The base station according to claim 78, wherein the noise or interference addition or the inclusion of a noise or interference equivalent parameter is interrupted when uplink to a base station, different from the base station at which noise or interference is added or noise or interference parameter is included, gets in sync.

100. The base station according to claim 99, wherein when noise or interference addition or noise or interference inclusion is interrupted, the processing means control transmission power control of the base station at which noise or interference is added or noise or interference is included to command a user equipment, to which the noise or interference addition or noise or interference parameter inclusion is related, to increase transmission power until handover is completed or the base station at which noise or interference addition or inclusion of noise or interference equivalent parameter is interrupted is no longer in the active set for the user equipment.

101. The radio communications base station according to claim 78, wherein the radio communications base station operates according to Code Division Multiple Access or Wideband Code Division Multiple Access principle.

102. The radio communications base station according to claim 78, wherein the radio communications base station operates according to principles of Orthogonal Frequency Division Multiplex, OFDM.
